(19) United States
(12) Patent Application Publication
(10) Pub. No.: US 2024/0192923 A1
(43) Pub. Date: Jun. 13, 2024

(54) SEMI-DEVICE-INDEPENDENT QUANTUM RANDOM NUMBER GENERATOR BASED ON HOMODYNE DETECTION

(71) Applicant: NATIONAL UNIVERSITY OF SINGAPORE, Singapore (SG)

(72) Inventors: Ignatius William PRIMAATMAJA, Singapore (SG); Ci Wen LIM, Singapore (SG); Koon Tong GOH, Singapore (SG)

(73) Assignee: NATIONAL UNIVERSITY OF SINGAPORE, Singapore (SG)

(21) Appl. No.: 18/556,255

(22) PCT Filed: Apr. 5, 2022
(86) PCT No.: PCT/SG2022/050195

§ 371 Date: Oct. 19, 2023

(30) Foreign Application Priority Data
Apr. 20, 2021 (SG) 10202104035W

(51) Int. Cl. G06F 7/58

(52) U.S. Cl. CPC G06F 7/588

(57) ABSTRACT

A method for providing a semi-device-independent random output signal, and a system for providing a semi-device-independent random output signal. The method comprises the steps of providing respective coherent laser signals of a same optical mode in a signal arm and a local oscillator arm between a quantum signal source, Alice, and at a quantum signal detector, Bob; Alice and Bob randomly selecting operation in a test mode or a randomness generation mode for each of n rounds; generating a raw random string from bit values bᵢ of rounds in which randomness generation mode was chosen, and using rounds in which test mode was chosen to estimate an entropy of the raw random string.

### FIELD OF INVENTION

The present invention relates broadly to a method for providing a semi-device-independent random output signal, in particular to a semi-device-independent quantum random number generator based on homodyne detection.

### BACKGROUND

Any mention and/or discussion of prior art throughout the specification should not be considered, in any way, as an admission that this prior art is well known or forms part of common general knowledge in the field.

Unlike pseudo-random number generators or random number generators that are based on classical processes, quantum random number generators (QRNGs) offer an edge for cryptographic purposes due to the randomness feature of quantum theory. More precisely, it is possible to certify that the numbers produced by a QRNG are random, not only to the users of the device, but also to any potential adversaries.

However, most existing practical QRNGs require accurate characterisation and modelling of the devices (source of quantum states and the devices for measurement on these states). Such QRNGs are called device-dependent QRNG. Since the certification of the devices is dependent on whether the mathematical model used to certify the randomness can perfectly describe the implementation, this raises a problem since the slightest mischaracterisation or fluctuation would render the randomness certificate invalid.

A semi-device-independent QRNG protocol based on homodyne detection has been proposed in which the sender uses binary phase-shift-keying coding which is then measured using homodyne detection. In the randomness certification, only the intensity of the states, i.e. the source of the quantum states, needs to be characterised. This protocol requires only a single quadrature measurement (the one that is aligned to the states). Consequently, this protocol has simple implementation but the security of this protocol can only be certified against classical adversaries. In other words, the scheme can certify that the random outputs are not pre-recorded, but it does not certify randomness against an adversary that might collect the inevitable leakage of quantum information due to system inefficiencies (such as channel loss, detection inefficiency, etc). Furthermore, since the measurement is performed in the same quadrature in which the states are prepared, the measurement outcome is inherently biased (conditioned on the input randomness). As such, the rate of random numbers after applying the extractor is limited.

In other proposed designs, no detailed characterisation of the quantum source nor measurements are required. The only requirement in the randomness certification is that the energy of the quantum states that the source produced are bounded by certain values. However, randomness is only certified against classical adversaries.

In another semi-device independent QRNG design, one can perform measurement tomography using trusted quantum states. This scheme is based on single-photon detection. Commercial single-photon detectors typically have lower detection efficiency and require some cooling mechanism to keep the background noise low. This would pose a challenge in integrating single-photon detection into photonic-integrated-circuits (PICs). Furthermore, their design requires a phase-randomised laser which would also limit the working frequency of the system due to phase correlation between adjacent pulses in high speed gain-switched laser system. Randomness is only certified against classical adversaries.

In another semi-device independent QRNG design based on the fundamental limit of unambiguous state discrimination (USD), when a measurement saturates the limit of USD, the underlying measurement must be a quantum measurement and therefore the outcomes are intrinsically random. This scheme is also based on single-photon detection and hence faces the same challenge in implementing the design in PICs. Randomness is only certified against classical adversaries.

Embodiments of the present invention seek to address at least one of the above problems.

### SUMMARY

In accordance with a first aspect of the present invention, there is provided a method for providing a semi-device-independent random output signal, the method comprising the steps of:
providing respective coherent laser signals of a same optical mode in a signal arm and a local oscillator arm between a quantum signal source, Alice, and at a quantum signal detector, Bob;
Alice and Bob randomly selecting operation in a test mode or a randomness generation mode for each of n rounds;
   wherein, if the test mode is chosen:
      Alice prepares a coherent test state of the laser signal in the signal arm uniformly chosen from a set of test states for transmission to Bob; and
      Bob measures the test state using a phase modulator in the local oscillator arm and a homodyne detector comprising a balanced beam splitter for the signal arm and the local oscillator arm and selects a bit value bᵢ depending on the measurement result;
   and wherein, if the randomness generation mode is chosen:
      Alice prepares a coherent default state of the laser signal in the signal arm for transmission to Bob; and
      Bob measures the coherent default state using the phase modulator in the local oscillator arm and the homodyne detector in the opposite observable compared to an X- or P-quadrature alignment of the coherent default state and selects respective bit values bᵢ depending on the measurement result;
and wherein the method further comprises
generating a raw random string from bit values bᵢ of rounds in which randomness generation mode was chosen, and
using rounds in which test mode was chosen to estimate an entropy of the raw random string.

In accordance with a second aspect of the present invention, there is provided a system for providing a semi-device-independent random output signal, the system comprising:
a laser source for providing respective coherent laser signals of a same optical mode in a signal arm and a local oscillator arm between a quantum signal source, Alice, and at a quantum signal detector, Bob;
a trusted random seed for Alice and Bob randomly selecting operation in a test mode or a randomness generation mode for each of n rounds;
   wherein, if the test mode is chosen:
      Alice is configured to prepare a coherent test state of the laser signal in the signal arm uniformly chosen from a set of test states for transmission to Bob; and
      Bob is configured to measure the test state using a phase modulator in the local oscillator arm and a homodyne detector comprising a balanced beam splitter for the signal arm and the local oscillator arm and selects a bit value bᵢ depending on the measurement result;
   and wherein, if the randomness generation mode is chosen:
      Alice is configured to prepare a coherent default state of the laser signal in the signal arm for transmission to Bob; and
      Bob is configured to measure the coherent default state using the phase modulator in the local oscillator arm and the homodyne detector in the opposite observable compared to an X- or P-quadrature alignment of the coherent default state and selects respective bit values bᵢ depending on the measurement result;
and further wherein
the system is configured to generate a raw random string from bit values b; of rounds in which randomness generation mode was chosen, and to use rounds in which test mode was chosen to estimate an entropy of the raw random string.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1, shows a schematic drawing illustrating a system for providing a semi-device-independent random output signal, according to an example embodiment.

FIG. 2 shows a flowchart illustrating a method for providing a semi-device-independent random output signal, according to an example embodiment.

### DETAILED DESCRIPTION

An example embodiment of the present invention can allow generation of random numbers that can be certified using the laws of quantum mechanics. By looking at the statistics of the output of the device according to an example embodiment, the output randomness can be certified without relying on the characterisation of the measurement device. As a result, this enhances the security and secrecy of the random numbers, hence making them suitable for applications such as cryptography, gaming, etc.

Two alternative protocols for quantum random number generation are provided in example embodiments described herein. Certifying the randomness obtained by the scheme according to the example embodiments does not require any characterisation of the measurement device (characterisation of the source of quantum states is still necessary). Therefore, the QRNG according to the example embodiments is semi-device-independent. Advantageously, the QRNG scheme according to the example embodiments produces unique correlations that cannot be reproduced using any classical processes. Moreover, based on the observed statistics, one can also bound the quantum information that is leaked into the environment. As such, the random numbers produced by the device according to the example embodiments would still be random to adversaries that hold quantum side information that is leaked due to channel imperfections. In the protocol, according to example embodiments some test rounds are used to look for these unique correlations and if they are observed, therefore one can conclude that the outcomes of the measurement device are random.

Unlike existing QRNG designs that are based on single-photon detection, the design according to the example embodiments is based on homodyne detection which typically has higher detection efficiency as well as the capability to operate at room temperature. Furthermore, homodyne detection can be easily implemented on a photonic integrated circuit (PIC). As such, the design according to the example embodiments can advantageously be implemented on PIC as well as in standard fibre-based systems. The ability to be implemented in PICs facilitates the miniaturisation of the design according to the example embodiments and it also paves the way to large-scale production which would make the design cost-effective. Additionally, the QRNG according to the example embodiments can be easily multiplexed which allows the protocol to be run in parallel. Effectively, this would increase the rate of randomness generation. Moreover, the randomness generated by the protocol according to the example embodiments can be proven secure against adversaries that hold quantum side information. In contrast, existing semi-device-independent QRNG protocols are only proven secure against adversaries holding classical side information.

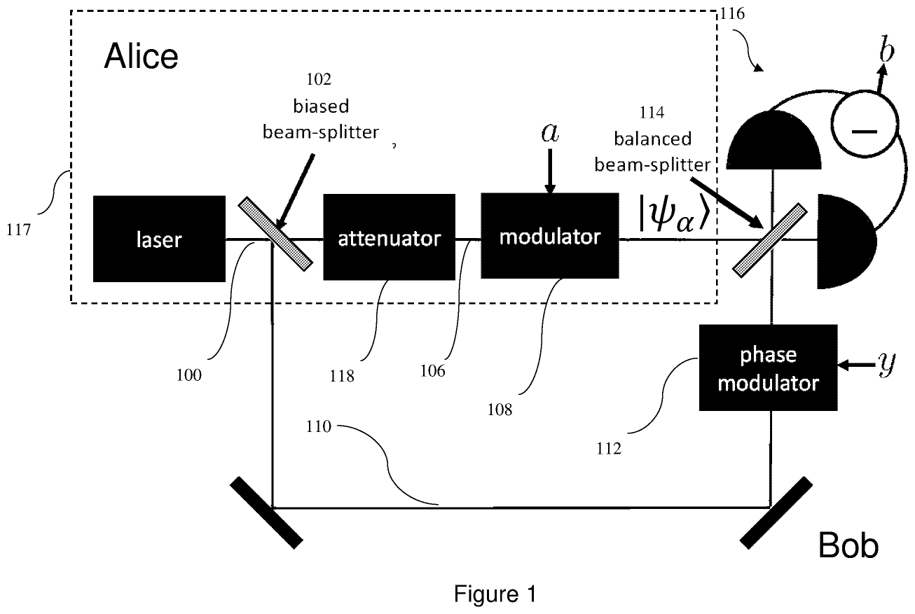

Details of the two different protocols according to the example embodiments will now be described with reference to FIG. 1. The two example embodiments correspond to two different state-preparation schemes, respectively.

As seen in FIG. 1, in this example embodiment the quantum states as well as the local oscillator of the homodyne detection are provided using a single laser beam 100 and splitting it using a biased beam-splitter 102. The biased beam-splitter 102 essentially produces two coherent states with the same spectral and polarisation mode and well-defined relative phase. Since the beam splitter 102 is biased, one arm 106 (“signal arm”) of the outputs will have a much weaker intensity than that of the other arm 110 (“local oscillator arm”). The coherent state in the signal arm 106 is used to modulate the quantum signal whereas the bright coherent state on the other arm 110 is used as the local oscillator of the homodyne measurement. It is noted that two lasers with the same optical mode may be used in a different example embodiment, such that one generates the signal pulse and the other generates the local oscillator. The advantage of using biased beam-splitter is that the polarisation and spectral mode as well as the global phase of the signal pulse and local oscillator is automatically matched. As such, active locking is not necessary.

The quantum states will then be prepared by modulating one arm 106 (“signal arm”) of the beam-splitter 102 using a modulator 108 (using a phase modulator for phase-shift-keying (PSK) protocol or in-phase-and-quadrature (IQ) modulator for quadrature-amplitude-modulation (QAM) protocol). On the other arm 110 (“local oscillator arm”), the phase of the local phase modulator 112 is controlled to choose whether one wants to measure the X or P-quadrature, and further using a balanced beam splitter 114 and homodyne detector 116. In the protocols according to the example embodiments, only the devices indicated within box 117 need to be characterised whereas the other devices are untrusted.

The detailed protocols according to the example embodiments are described below. In the following protocol description, the components that prepare the quantum signals are referred to as “Alice” and the components that detect the quantum signals are referred to as “Bob”.

### Protocol 1st Embodiment: N-Phase-Shift-Keying Protocol

In this protocol, a set of test states is defined as

$$S = \{ \vert a {e}^{- i \frac{2 a π}{N}} 〉 \vert a ∈ \{ 0 , 1 , … , N - 1 \} \}$$

1. Calibration: Turn on the laser and pass the laser beam 100 into the biased beam-splitter 102 such that one of the output modes (in arm 106) is the signal mode and the other is the local (i.e. Bob's) oscillator mode (in arm 110). Calibrate the intensity of the signal mode to an appropriate value using an optical attenuator 118. As will be appreciated by a person skilled in the art, the appropriate intensity would generally depend on the efficiency of the homodyne detector as well as the number of states used in the protocol (i.e., N).
2. Choosing randomness generation or test round:
   For each round i∈{1, 2, . . . , n}, using a trusted random seed, Alice and Bob both choose tᵢ∈{0,1} from the probability distribution {1−γ, γ}. If tᵢ=0, then randomness generation mode is chosen and if tᵢ=1, then test mode is chosen.
3. State preparation and measurement: If randomness generation mode is chosen (tᵢ=0), then Alice sets aᵢ=0 and Bob sets yᵢ=0. If test mode is chosen (tᵢ=1), Alice uses a trusted random seed to set aᵢ=a∈{0,1, . . . , N−1} and Bob uses the trusted random seed to set yᵢ=y∈{0,1}, with probability q(a, y). Alice and Bob both use the same source of random inputs in the example embodiment, (i.e., the random inputs do not have to be independent), but the value of a and y could be different.
   In either mode, Alice would then prepare the state

$$\vert α {e}^{- i \frac{2 {a}_{i} π}{N}} 〉$$

and send it to Bob. That is, in the randomness generation mode, Alice generates a “default” state which is aligned to the X-quadrature, based on aᵢ=0, whereas in the test mode, Alice generates a coherent test state uniformly chosen from a set of test states.
If yᵢ=0. Bob measures the P-quadrature and if yᵢ=1, then Bob measures the X-quadrature. In either case, Bob will record the sign of the measurement outcome and if the sign is positive, Bob will set his bit value as bᵢ=0, else he sets bᵢ=1. That is, in the randomness generation mode, Bob measures the P-quadrature, based on yᵢ=0, of the default state aligned to the X-quadrature, whereas in the test mode, Bob uniformly choses the P- or X-quadrature measurement. As will be appreciated by a person skilled in the art, the P-quadrature measurement on the default state aligned to the X-quadrature will randomly result in positive or negative sign in the randomness generation mode.
It is noted that in a different embodiment, the default state can be aligned to the P-quadrature (not X-quadrature) and then Bob measures the X-quadrature (not P-quadrature) to generate the random numbers.
Repeat steps 2 and 3 for n times.
The set of randomness generation rounds is defined as R={i|tᵢ=0} and the set of test rounds is defined as T={i|tᵢ=1}. The raw random string is given by \vec{s}={bᵢ|i∈R}
4. Parameter estimation: For all rounds in T. Alice will announce aᵢ and Bob will announce bᵢ. From the classical announcement, Alice and Bob will estimate the set of conditional probabilities {Pr(b|a, y)}_{a,b,y} for all a∈{0,1, . . . , N−1}, b∈{0,1} and y∈{0,1}. This data will be used to estimate the entropy of the raw string s.
1. Randomness extraction: Bob will apply randomness extraction on the raw string s to obtain a string that is perfectly random. Since entropy accumulation theorem can be used to certify that the protocol produces positive conditional smooth minimum-entropy requirement (compare step 4) against quantum side information when not aborted, randomness generated by the protocol can be certified against adversaries who hold quantum side information if a quantum-secure randomness extractor is used. It is noted that the conditional smooth-min entropy requirement would depend on many parameters, as will be appreciated by a person skilled in the art: the length of the output random string, the level of security that is desired, the tolerated probability of aborting the protocol even when the device works as expected, etc.

### Protocol 2nd Embodiment: 4^{M} Quadrature Amplitude Modulation Protocol

In this protocol, the set of test states is defined as

$$S = \{ \vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{α}{\sqrt{2}} {e}^{- i \frac{π}{4}} 〉 \vert {x}_{a} , {p}_{a} ∈ \{ 0 , 1 , … , M - 1 \} , {a}_{1} , {a}_{2} ∈ \{ 0 , 1 \} \}$$

2. Calibration: Turn on the laser and pass the laser beam 100 into the biased beam-splitter 1-2 such that one of the output modes is the signal mode (in arm 106) and the other is the local (to Bob) oscillator mode (in arm 110). Calibrate the intensity of the signal mode to an appropriate value using the optical attenuator 118. As will be appreciated by a person skilled in the art, the appropriate intensity would generally depend on the efficiency of the homodyne detector as well as the number of states used in the protocol (i.e., M).
3. Choosing randomness generation or test round:
   For each round i∈{1, 2, . . . , n}, using a trusted random seed, Alice and Bob both choose tᵢ∈{0,1} from the probability distribution {1−γ, γ}. If tᵢ=0, then randomness generation mode is chosen and if tᵢ=1, then test mode is chosen.
4. State preparation and measurement:
   If randomness generation mode is chosen (tᵢ=0), then Alice sets the tuple aᵢ=(0,0,0,0) and Bob sets yᵢ=0. If test mode is chosen (tᵢ=1), Alice uses a trusted random seed to set the tuple aᵢ=a=(xₐ, pₐ, a₁, a₂), where xₐ, pₐ∈{0,1, . . . , M−1} and a₁, a₂∈{0,1}, and Bob uses the trusted random seed to set yᵢ=y∈{0,1} with probability q(a, y). Alice and Bob both use the same source of random inputs in the example embodiment, (i.e., the random inputs do not have to be independent), but the value of a and y could be different.
   In either mode, Alice would then prepare the state

$$\vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{α}{\sqrt{2}} {e}^{- i \frac{π}{4}} 〉$$

and send it to Bob. That is, in the randomness generation mode, Alice generates a “default” state which is aligned to the X-quadrature, based on aᵢ=(0,0,0,0), whereas in the test mode, Alice generates a coherent test state uniformly chosen from a set of test states.
If yᵢ=0, Bob measures the P-quadrature and if yᵢ=1, then he measures the X-quadrature. In either case, he will record the sign of his measurement outcome and if the sign is positive, he will set his bit value as bᵢ=0, else he sets bᵢ=1. That is, in the randomness generation mode, Bob measures the P-quadrature, based on yᵢ=0, whereas in the test mode, Bob uniformly choses between the P- or X-quadrature measurements. As will be appreciated by a person skilled in the art, the P-quadrature measurement on the default state aligned to the X-quadrature will randomly result in positive or negative sign in the randomness generation mode.
It is noted that in a different embodiment, the default state can be aligned to the P-quadrature (not X-quadrature) and then Bob measures the X-quadrature (not P-quadrature) to generate the random numbers.
Repeat step 2 and 3 for n times.
The set of randomness generation rounds is defined as R={i|tᵢ=0} and the set of test rounds is defined as T={i|t; =1}. The raw random string is given by \vec{s}={bᵢ|i∈R}
5. Parameter estimation: For all rounds in T, Alice will announce di and Bob will announce bᵢ. From the classical announcement, Alice and Bob will estimate the set of conditional probabilities {Pr(b|a, y)}_{a,b,y} for all a∈{(xₐ, pₐ, a₁, a₂)|xₐ, pₐ∈{0,1, . . . , M−1} and a₁, a₂∈{0,1}}, b∈{0,1} and y∈{0,1}. This data will be used to estimate the entropy of the raw string s. Since Alice prepares non-orthogonal quantum states, there is a trade-off between how strongly Alice's data (a) and Bob's data (b) are correlated and the correlation between Bob's data and the adversary's guess. By estimating {Pr(b|a,y)}, one can measure the correlation between Alice's and Bob's data and hence, one can bound how well the adversary can guess Bob's measurement outcome. The formal proof involves maximising the probability of the adversary guessing b correctly, subject to the statistics observed during the protocol (i.e. {Pr(b|a,y)}). This maximisation can be cast as a semidefinite programming discussed below for an example embodiment.
6. Randomness extraction: Bob will apply randomness extraction on the raw string § to obtain a string that is perfectly random. Since entropy accumulation theorem can be used to certify that the protocol produces positive conditional smooth minimum-entropy requirement (compare step 4) against quantum side information when not aborted, randomness generated by the protocol can be certified against adversaries who hold quantum side information if a quantum-secure randomness extractor is used. It is noted that the conditional smooth-min entropy requirement would depend on many parameters, as will be appreciated by a person skilled in the art: the length of the output random string, the level of security that is desired, the tolerated probability of aborting the protocol even when the device works as expected, etc.

It was found that, using QAM encoding (2nd embodiment) gives higher randomness generation rate than PSK encoding (1st embodiment).

In both protocols according to the respective example embodiments, random numbers are generated when Alice prepares a default coherent state that is aligned to the X-quadrature and Bob measures that state in the P-quadrature. In the ideal scenario, this would indeed produce uniformly random output. To certify the amount of entropy contained in the raw string \vec{s}, entropy accumulation theorem and semidefinite programming to bound the adversary's guessing probability can be used, subject to the statistics that one observes in the parameter estimation step of each protocol. The set S can be optimized by calculating the min-entropy over different values of a and choose the value which gives the highest min-entropy. Finally, by using a randomness extraction method, one can obtain a certifiable, uniformly-random string of numbers. It is noted that any quantum-secure randomness extraction protocol (such as the Trevisan, Toeplitz or even two-source extractor) can be used. It is also noted that the protocol uses initial seed of randomness to choose the inputs for Alice and Bob. However, if the bias of the random seed is tuned to an appropriate value, the protocol can advantageously produce more randomness than the initial amount of randomness that is used to choose the inputs. The optimal probability distribution of the initial seed would depend on the efficiency of the homodyne detector, the block size and the states being used in the protocol.

It is noted again that in a different embodiment, the default state can be aligned to the P-quadrature (not X-quadrature) and then Bob measures the X-quadrature to generate the random numbers and P-quadrature to test.

As described above, two protocols according to respective example embodiments have been provided for semi-device-independent QRNG based on homodyne detection scheme. Advantageously, the randomness certification is independent on the characterisation of the homodyne detector which would significantly relax the burden of characterising a complicated detection scheme such as homodyne detection. Additionally, since entropy accumulation theorem certifies that both protocols produce positive conditional smooth min-entropy against quantum side information when they are not aborted, randomness generated by the protocols according to the respective example embodiments can be certified against adversaries who hold quantum side information if a quantum-secure randomness extractor is used. The security definition of the quantum-secure randomness extractors can hence be guaranteed that as long as the min-entropy (conditional on any quantum side information) fulfills the desired requirement, unlike previous semi-device-independent QRNG schemes which are only proven secure against adversaries holding classical side information. This advantageously ensures the security of the output random numbers even if unintended leakage of quantum signals is detected by the adversary. It is noted again that the conditional smooth-min entropy requirement would depend on many parameters, as will be appreciated by a person skilled in the art: the length of the output random string, the level of security that is desired, the tolerated probability of aborting the protocol even when the device works as expected, etc.

Since the design according to the example embodiments is based on homodyne detection, one can implement the protocols on both fibre-based systems and photonic-integrated-circuits (PICs) at room temperature. PIC implementation can significantly reduce the cost and size of the QRNG which is of great interest to consumers.

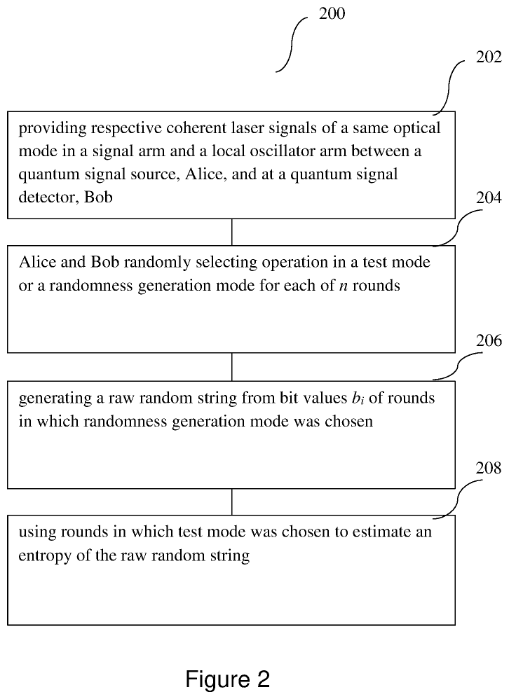

FIG. 2 shows a flowchart 200 illustrating a method for providing a semi-device-independent random output signal, according to an example embodiment. At step 202, respective coherent laser signals of a same optical mode are provided in a signal arm and a local oscillator arm between a quantum signal source, Alice, and at a quantum signal detector, Bob. At step 204, Alice and Bob randomly select operation in a test mode or a randomness generation mode for each of n rounds;
wherein, if the test mode is chosen:
   Alice prepares a coherent test state of the laser signal in the signal arm uniformly chosen from a set of test states for transmission to Bob; and
   Bob measures the test state using a phase modulator in the local oscillator arm and a homodyne detector comprising a balanced beam splitter for the signal arm and the local oscillator arm and selects a bit value b; depending on the measurement result;
and wherein, if the randomness generation mode is chosen:
   Alice prepares a coherent default state of the laser signal in the signal arm for transmission to Bob; and
   Bob measures the coherent default state using the phase modulator in the local oscillator arm and the homodyne detector in the opposite observable compared to an X- or P-quadrature alignment of the coherent default state and selects respective bit values bᵢ depending on the measurement result.

At step 206, a raw random string is generated from bit values b; of rounds in which randomness generation mode was chosen. At step 208, rounds in which test mode was chosen are used to estimate an entropy of the raw random string.

The method may comprise Alice preparing the coherent default state using a phase modulator. The method may comprise Alice preparing the coherent test states based on the random symbol a, chosen from a predetermined probability distribution, from a set of test states

$$S = \{ \vert α {e}^{- i \frac{2 a π}{N}} 〉 \vert a ∈ \{ 0 , L , … , N - 1 \} \}$$

The method may comprise Alice preparing the coherent default state using an IQ modulator. The method may comprise Alice preparing the coherent test states based on the tuple a, whose elements are xₐ, pₐ, a₁, a₂ and each element is chosen from a predetermined probability distribution, from a set of test states

$$S = \{ \vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{a}{\sqrt{2}} {e}^{- i \frac{π}{4}} 〉 \vert {x}_{a} , {p}_{a} ∈ \{ 0 , 1 , … , M - 1 \} , {a}_{1} , {a}_{2} ∈ \{ 0 , 1 \} \}$$

The method may comprise Bob applying a randomness extractor to the raw random string.

If the randomness generation mode is chosen, Bob may measure the P-quadrature of the coherent default state having an X-quadrature alignment.

If the randomness generation mode is chosen, Bob may measure the X-quadrature of the coherent default state having a P-quadrature alignment.

If the test mode is chosen, Bob may uniformly chose between P- or X-quadrature measurements of the test state.

In one embodiment, a system for providing a semi-device-independent random output signal is provided, the system comprising a laser source for providing respective coherent laser signals of a same optical mode in a signal arm and a local oscillator arm between a quantum signal source, Alice, and at a quantum signal detector, Bob; a trusted random seed for Alice and Bob randomly selecting operation in a test mode or a randomness generation mode for each of n rounds;
wherein, if the test mode is chosen:
   Alice is configured to prepare a coherent test state of the laser signal in the signal arm uniformly chosen from a set of test states for transmission to Bob; and
   Bob is configured to measure the test state using a phase modulator in the local oscillator arm and a homodyne detector comprising a balanced beam splitter for the signal arm and the local oscillator arm and selects a bit value bᵢ depending on the measurement result;
and wherein, if the randomness generation mode is chosen:
   Alice is configured to prepare a coherent default state of the laser signal in the signal arm for transmission to Bob; and
   Bob is configured to measure the coherent default state using the phase modulator in the local oscillator arm and the homodyne detector in the opposite observable compared to an X- or P-quadrature alignment of the coherent default state and selects respective bit values bᵢ depending on the measurement result;
and further wherein the system is configured to generate a raw random string from bit values bᵢ of rounds in which randomness generation mode was chosen, and to use rounds in which test mode was chosen to estimate an entropy of the raw random string.

Alice may be configured to prepare the coherent default state using a phase modulator. Alice may be configured to prepare the coherent test states based on the random symbol a, chosen from a predetermined probability distribution, from a set of test states

$$S = \{ \vert α {e}^{- i \frac{2 a π}{N}} 〉 \vert a ∈ \{ 0 , 1 , … , N - 1 \} \}$$

Alice may be configured to prepare the coherent default state using an IQ modulator. Alice may be configured to prepare the coherent test states based on the tuple a, whose elements are xₐ, pₐ, a₁, a₂ and each element is chosen from a predetermined probability distribution, from a set of test states

$$S = \{ \vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{a}{\sqrt{2}} {e}^{- i \frac{π}{4}} 〉 \vert {x}_{a} , {p}_{a} ∈ \{ 0 , 1 , … , M - 1 \} , {a}_{1} , {a}_{2} ∈ \{ 0 , 1 \} \}$$

Bob may be configured to apply a randomness extractor to the raw random string.

If the randomness generation mode is chosen, Bob may be configured to measure the P-quadrature of the coherent default state having an X-quadrature alignment.

If the randomness generation mode is chosen, Bob may be configured to measure the X-quadrature of the coherent default state having a P-quadrature alignment.

If the test mode is chosen, Bob may be configured to uniformly chose between the P- or X-quadrature measurements of the test state.

Embodiments of the present invention can have one or more of the following features and associated benefits/advantages:

| Feature | Benefit/Advantage |
|---|---|
| Semi-device-independent | Since the randomness certification is |
| | independent of the characterisation of the |
| | measurement device, the security claim is |
| | robust against any fluctuation in the working |
| | of the measurement device as well as any |
| | possible mischaracterisation of the |
| | measurement device. |
| Cost-effective | Since the design is based on homodyne |
| | measurement which has been implemented |
| | in photonic-integrated-circuit (PIC), the |
| | production of the design is easily scalable. |
| | This would lower the large scale production |
| | cost of the design. |
| High speed | Due to the compatibility with PIC |
| | implementation, the design can be easily |
| | multiplexed and therefore the protocol can be |
| | run in parallel. This would significantly |
| | increase the rate of randomness produced by |
| | the protocol. |
| Secure against | the protocol is proven to be information- |
| quantum adversary | theoretically secure against adversaries that |
| | hold any quantum side information obtained |
| | from the channel imperfection. This provides |
| | the users with the highest level of security |
| | allowed by quantum theory. In particular, the |
| | quantum random number generator remains |
| | secure even if there is unintended leakage of |
| | quantum information due to channel |
| | imperfections. |

Aspects of the systems and methods described herein, such as, but not limited to, the signal modulation, signal detection and processing, and the randomness extraction, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics, Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize.

The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise.” “comprising.” and the like are to be construed in an inclusive sense as opposed to an exclusive or exhaustive sense; that is to say, in a sense of “including, but not limited to.” Words using the singular or plural number also include the plural or singular number respectively. Additionally, the words “herein.” “hereunder.” “above.” “below.” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A method for providing a semi-device-independent random output signal, the method comprising the steps of:
providing respective coherent laser signals of a same optical mode in a signal arm and a local oscillator arm between a quantum signal source, Alice, and at a quantum signal detector, Bob;
Alice and Bob randomly selecting operation in a test mode or a randomness generation mode for each of n rounds;
wherein, if the test mode is chosen:
Alice prepares a coherent test state of the laser signal in the signal arm uniformly chosen from a set of test states for transmission to Bob; and
Bob measures the test state using a phase modulator in the local oscillator arm and a homodyne detector comprising a balanced beam splitter for the signal arm and the local oscillator arm and selects a bit value bᵢ depending on the measurement result;
and wherein, if the randomness generation mode is chosen:
Alice prepares a coherent default state of the laser signal in the signal arm for transmission to Bob; and
Bob measures the coherent default state using the phase modulator in the local oscillator arm and the homodyne detector in the opposite observable compared to an X- or P-quadrature alignment of the coherent default state and selects respective bit values bᵢ depending on the measurement result;
and wherein the method further comprises generating a raw random string from bit values bᵢ of rounds in which randomness generation mode was chosen, and
using rounds in which test mode was chosen to estimate an entropy of the raw random string.

2. The method of claim 1, comprising Alice preparing the coherent default state using a phase modulator.

3. The method of claim 2, comprising Alice preparing the coherent test states based on the random symbol a, chosen from a predetermined probability distribution, from a set of test states
$$S = \{ \vert α {e}^{- i \frac{2 a π}{N}} 〉 \vert a ∈ \{ 0 , 1 , … , N - 1 \} \} .$$

4. The method of claim 1, comprising Alice preparing the coherent default state using an IQ modulator.

5. The method of claim 4, comprising Alice preparing the coherent test states based on the tuple a, whose elements are xₐ, pₐ, a₁, a₂ and each element is chosen from a predetermined probability distribution, from a set of test states
$$S = \{ \vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{α}{\sqrt{2}} {e}^{- i \frac{π}{4}} 〉 \vert {x}_{a} , {p}_{a} ∈ \{ 0 , 1 , … , M - 1 \} , {a}_{1} , {a}_{2} ∈ \{ 0 , 1 \} \} .$$

6. The method of claim 1, comprising Bob applying a randomness extractor to the raw random string.

7. The method of claim 1, wherein, if the randomness generation mode is chosen, Bob measures the P-quadrature of the coherent default state having an X-quadrature alignment.

8. The method of claim 1, wherein, if the randomness generation mode is chosen, Bob measures the X-quadrature of the coherent default state having a P-quadrature alignment.

9. The method of claim 1, wherein, if the test mode is chosen, Bob uniformly choses between P- or X-quadrature measurements of the test state.

10. A system for providing a semi-device-independent random output signal, the system comprising:
a laser source for providing respective coherent laser signals of a same optical mode in a signal arm and a local oscillator arm between a quantum signal source, Alice, and at a quantum signal detector, Bob;
a trusted random seed for Alice and Bob randomly selecting operation in a test mode or a randomness generation mode for each of n rounds;
wherein, if the test mode is chosen:
Alice is configured to prepare a coherent test state of the laser signal in the signal arm uniformly chosen from a set of test states for transmission to Bob; and
Bob is configured to measure the test state using a phase modulator in the local oscillator arm and a homodyne detector comprising a balanced beam splitter for the signal arm and the local oscillator arm and selects a bit value bᵢ depending on the measurement result;
and wherein, if the randomness generation mode is chosen:
Alice is configured to prepare a coherent default state of the laser signal in the signal arm for transmission to Bob; and
Bob is configured to measure the coherent default state using the phase modulator in the local oscillator arm and the homodyne detector in the opposite observable compared to an X- or P-quadrature alignment of the coherent default state and selects respective bit values bᵢ depending on the measurement result;
and further wherein
the system is configured to generate a raw random string from bit values bᵢ of rounds in which randomness generation mode was chosen, and to use rounds in which test mode was chosen to estimate an entropy of the raw random string.

11. The system of claim 10, wherein Alice is configured to prepare the coherent default state using a phase modulator.

12. The system of claim 11, wherein Alice is configured to prepare the coherent test states based on the random symbol a, chosen from a predetermined probability distribution, from a set of test states
$$S = \{ \vert α {e}^{- i \frac{2 a π}{N}} 〉 \vert a ∈ \{ 0 , 1 , … , N - 1 \} \} .$$

13. The system of claim 10, wherein Alice is configured to prepare the coherent default state using an IQ modulator.

14. The system of claim 13, wherein Alice is configured to prepare the coherent test states based on the tuple a, whose elements are xₐ, pₐ, a₁,a₂ and each element is chosen from a predetermined probability distribution, from a set of test states
$$S = \{ \vert [ {( - 1 )}^{{a}_{1}} ( {x}_{a} + \frac{1}{2} ) + {( - 1 )}^{{a}_{2}} i ( {p}_{a} + \frac{1}{2} ) ] \frac{α}{\sqrt{2}} {e}^{- i \frac{π}{4}} 〉 \vert {x}_{a} , {p}_{a} ∈ \{ 0 , 1 , … , M - 1 \} , {a}_{1} , {a}_{2} ∈ \{ 0 , 1 \} \} .$$

15. The system of claim 10, wherein Bob is configured to apply a randomness extractor to the raw random string.

16. The system of claim 10, wherein, if the randomness generation mode is chosen, Bob is configured to measure the P-quadrature of the coherent default state having an X-quadrature alignment.

17. The system of claim 10, wherein, if the randomness generation mode is chosen, Bob is configured to measure the X-quadrature of the coherent default state having a P-quadrature alignment.

18. The system of claim 10, wherein, if the test mode is chosen, Bob is configured to uniformly chose between P- or X-quadrature measurements of the test state.
